(19) United States
(12) Patent Application Publication
(10) Pub. No.: US 2012/0079573 A1
(43) Pub. Date: Mar. 29, 2012

(54) INFORMATION PROCESSING DEVICE, PASSWORD DIAGNOSING METHOD AND COMPUTER-READABLE MEDIUM

(75) Inventors: Akihiro Sagawa, Kahoku-shi (JP); Yasuhiko Kometani, Kahoku-shi (JP); Akira Kubota, Kahoku-shi (JP); Kenichi Higashide, Kahoku-shi (JP)

(73) Assignee: PFU LIMITED, Kahoku-shi (JP)

(21) Appl. No.: 13/223,671

(22) Filed: Sep. 1, 2011

(30) Foreign Application Priority Data
Sep. 29, 2010 (JP) 2010-219455

(51) Int. Cl. G06F 21/00

(52) U.S. Cl. 726/6

(57) ABSTRACT

A user terminal includes a diagnosing unit 23 conducting a password diagnosis based on a password trial; a recording unit 24 recording time related to the password diagnosis; an information acquiring unit 21 acquiring the time related to the password diagnosis of the last time, which is recorded by the recording unit 24, as the time of last diagnosis and acquiring reference time for determining whether the password diagnosis is required or not; and a determining unit 22 determining whether or not the time of last diagnosis conforms with a predetermined condition with the reference time serving as a benchmark, wherein the diagnosing 23, if the determining unit 22 determines that the time of last diagnosis conforms with the predetermined condition with the reference time serving as the benchmark, performs the password diagnosis.

### CROSS-REFERENCE TO RELATED APPLICATION

This application is based upon and claims the benefit of priority of the prior Japanese Patent Application No. JP2010-219455, filed on Sep. 29, 2010, the entire contents of which are incorporated herein by reference.

### FIELD

This disclosure relates to a password diagnosis.

### BACKGROUND

There is a security countermeasure effect output device (refer to Japanese Patent Application Laid-Open Publication No. 2003-256369) which executes a process of acquiring user identifier information registered in a countermeasure target computer, generating a single or a plurality of vulnerable passwords, making a trial of logging on to the countermeasure target computer by designating the user identifier information and the vulnerable password and blocking, if the trial is successful, a log-on request to the countermeasure target computer, which designates the user identifier information and the vulnerable password each used when succeeding in the trial.

Further, there is a password selection support system (refer to Japanese Patent Application Laid-Open Publication No. 2001-134491) which compares a hash value of a password of which a password length and a character type are checked with a hash value accumulated in a dictionary database, determines whether or not the hash value of the password matches with any one of the hash values of the accumulated entry words and, if not matched, registers the hash value of the password.

In a computer system, if the password set by a user is an easy-to-guess password, such a possibility rises that a third party, malware, etc succeeding in guessing the password might exploit the system. Therefore, a system administrator is required to confirm that the password set by the user is not the easy-to-guess password and to keep the security of the system.

Such being the case, a change of the password needs an old password, and hence there are utilized a password diagnosing method of making a trial of changing the password by use of the easy-to-guess password through invoking API (Application Programming Interface) of OS (Operating System) and determining, if the change can be done, that the vulnerable password is used, a password diagnosing method of making the trial of logging in to the system by using the easy-to-guess password and, if succeeding in the log-in, determines that the vulnerable password is employed, and so on.

In the password diagnosing method based on the password trial described above, however, a record of a failure in the password trial remains in a system log. Therefore, if there are an increased number of logs each representing the failure in the password trial on the basis of the password diagnosis, there exists a problem of raising a possibility that the system or the administrator might overlook a real attack because of a difficulty of distinguishing between the log derived from the password diagnosis and the log derived from the real attack (the malicious password analyzing action).

### SUMMARY

One aspect of the disclosure provides an information processing device including: a diagnosing unit conducting a password diagnosis based on a password trial; a recording unit recording time related to the password diagnosis; an information acquiring unit acquiring the time related to the password diagnosis of the last time, which is recorded by the recording unit, as the time of last diagnosis and acquiring reference time for determining whether the password diagnosis is required or not; and a determining unit determining whether or not the time of last diagnosis conforms with a predetermined condition with the reference time serving as a benchmark, wherein the diagnosing unit, if the determining unit determines that the time of last diagnosis conforms with the predetermined condition with the reference time serving as the benchmark, performs the password diagnosis.

Further, this disclosure can be grasped as a method executed by a computer or a program executed by the computer. Still further, one aspect of the disclosure provides a non-transitory recording medium recorded with such a program, which can be read by the computer, other devices, other machines, etc. Herein, the recording medium readable by the computer etc connotes a recording medium capable of storing information such as data and programs electrically, magnetically, optically, mechanically or by chemical action, which can be read from the computer etc.

### BRIEF DESCRIPTION OF THE DRAWINGS

FIG. 1 is a schematic diagram illustrating an architecture of a computer system according to an embodiment.

FIG. 2 is a diagram illustrating an outline of a functional configuration of a user terminal according to the embodiment.

FIG. 3 is a flowchart illustrating a flow of a password diagnosis process according to the embodiment.

FIG. 4 is a flowchart illustrating a variation of a password diagnosis process according to the embodiment.

FIG. 5 is a flowchart illustrating the variation of the password diagnosis process according to the embodiment.

### DESCRIPTION OF EMBODIMENTS

An embodiment will hereinafter be described with reference to the drawings. It should be noted that the embodiment, which will hereinafter be discussed, is illustrated by way of one example of the embodiments but does not limit a specific configuration through which this disclosure will be described as below. On the occasion of carrying out one aspect of the disclosure, it is preferable that the specific configuration corresponding to an embodiment is properly adopted.

<System Architecture>

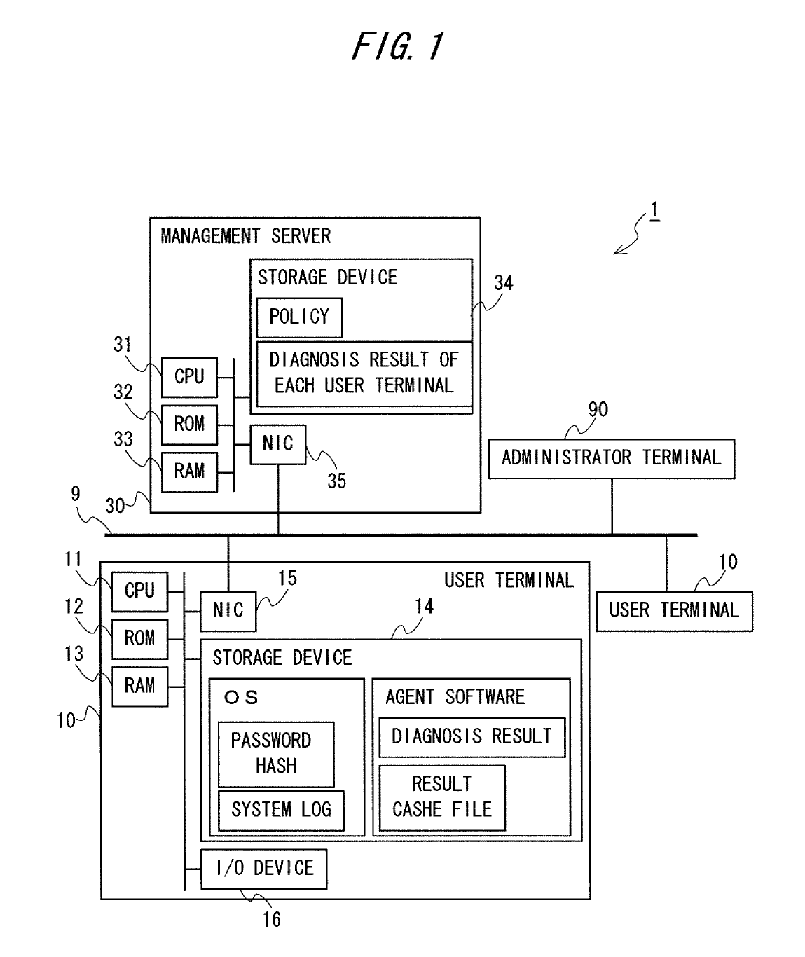

FIG. 1 is a schematic diagram illustrating an architecture of a computer system 1 according to the embodiment. In the embodiment, an information processing device according to this disclosure is embodied as a user terminal 10 utilized by a user. The computer system 1 according to the embodiment includes a single or a plurality of user terminals 10, a management server 30 which provides a management service to the user terminal 10 and an administrator terminal 90 which is operated by an administrator and performs a variety of settings for the management server 30. In the computer system 1, the user terminal 10, the management server 30 and the administrator terminal 90 are connected to each other in a mutual-communication-enabled manner via a network 9. Note that the network 9 can involve using, e.g., a LAN (Local Area Network). The network 9 may, however, involve using, in addition to the LAN, a network in which to connect a WAN (Wide Area Network), the Internet, a mobile phone network, a private line, a private network, an Intranet, etc to each other.

The user terminal 10 is a computer equipped with a CPU (Central Processing Unit) 11, a RAM (Random Access Memory) 13, a ROM (Read Only Memory) 12, a storage device 14 such as an EEPROM (Electrically Erasable and Programmable Read Only Memory) and a HDD (Hard Disk Drive), a communication unit 15, an input/output (I/O) device 16 such as a display, a mouse and a keyboard, and so on. Further, the user terminal 10 may also be equipped with a touch panel display, a loudspeaker, a display, a printer, a card reader, etc as the I/O devices.

The CPU 11, which is the central processing unit, processes instructions and data deployed on the RAM 13 etc, thereby controlling the RAM 13, the storage device 14, the I/O device 16, etc. The RAM 13, which is a main storage device, is controlled by the CPU 11, thus writing and reading the variety of instructions and various items of data to and from the RAM 13. The storage device 14 is a nonvolatile storage device to and from which want-to-retain items of information even in a power-off status of mainly the user terminal 10 are written and read. The I/O device 16 is controlled by the CPU 11, thus displaying the output display data and accepting a user's operation. A content inputted from the I/O device 16 is recorded on the RAM 13 and processed by the CPU 11.

The storage device 14 is stored with, in addition to OS of the user terminal 10 that is loaded into the RAM 13 and executed by the CPU 11, a piece of agent software used for the management server 30 to manage the user terminals 10. The agent software includes a password diagnosis program.

In the embodiment, the user terminal 10 executes the password diagnosis program and thus determines whether a password set by the user in the system of the user terminal 10 is valid or not. Generally, the set password information is concealed by the system. Therefore, in the embodiment, the user terminal 10 employs a technique of trying to input the password to the system in order to check the validity of the already-set password. The diagnosis target password may not be a password that is set in the system. For example, the diagnosis target password may be a password set in an individual application used on the user terminal 10 and may also be a password set for a service utilized on the user terminal 10 via the network.

The storage device 14 is recorded with a password hash (a hash value of the password) and a system log, which are managed by the OS. The OS of the user terminal 10 according to the embodiment does not retain the password in plain text but retains only the hash value of the password in order to prevent the password from leaking out. The user terminal 10, when the user sets the password, calculates the hash value of the password, and records the hash value of the password in the way of being associated with the user who sets the password in the storage device 14. In normal log-in, the user terminal 10, when the user inputs the password, calculates the hash value of the inputted password and compares this hash value of the inputted password with the password hash recorded in the storage device 14. As a result of the comparison, the log-in is permitted if the hash value of the inputted password is coincident with the password hash recorded in the storage device 14 but is rejected whereas if not coincident.

Further, the OS of the user terminal 10, as the user employs the user terminal (system) 10, records the system log in the storage device 14. What is retained in the system log includes a log-in history of the user, an operation history of the use, a system-based processing history, a system-based communication history, etc. Moreover, the user terminal 10 according to the embodiment is accumulated with an event that a wrong (invalid) password is inputted (a failure in log-in) as the system log.

Further, the storage device 14 is recorded with a diagnosis result and a result cache file, which are managed by the agent software. The user terminal 10 executing the agent software accumulates the password diagnosis result, which will be described later on, on a user-by-user basis or a system-by-system basis. Moreover, the user terminal 10 executing the agent software stores the last password diagnosis result (of the last time) on the user-by-user basis or the system-by-system basis in a result cache file on the storage device 14 as the result cache. In the embodiment, the result cache contains last time information indicating the time when the password diagnosis has been completed lastly and a diagnosis result (last diagnosis result) of the password diagnosis that has been completed lastly. There is a case in which a plurality of user accounts is set in the system, and therefore the result cache file can contain a plurality of result caches on the per user basis.

It should be noted that the embodiment will discuss the case in which the result cache is stored in the result cache file defined as the file on the file system. The result cache may, however, be stored in a storage area and a registry on a memory, a remotely-connected storage device and other types of storage locations, instead of the file on the file system.

In the embodiment, the management server 30 is, similarly to the user terminal 10, a computer in which a CPU 31, a RAM 33, a ROM 32, a storage device 34 such as the HDD, a communication unit 35, etc are connected to each other.

The storage device 34 of the management server 30 retains a policy and the diagnosis result of each user terminal 10. Herein, the “policy” is defined as information representing a management policy of the user terminal 10, which is applied by the management server 30 to the user terminal 10 via the agent software etc. The “policy” includes a variety of policies related to the management of the user terminal 10 such as contents that should be set in the system for the user terminal 10, designation of the software that should be operated on the user terminal 10 and setting contents of the software. Herein, in the embodiment, an easy-to-guess password (vulnerable password), which should be used for the password diagnosis on the user terminal 10, may be designated in the policy. If the easy-to-guess password that should be used for the password diagnosis is designated in the policy, the user terminal 10 prepares at least a part of the password used for a password trial in a password diagnosis process that will be described later on by acquiring this fragment of the password from the management server 30.

Further, the management server 30 accumulates, in the storage device 34, the diagnosis result (refer to step S109 that will hereafter be explained) of which the user terminal 10 notifies in the way of being associated with user information related to the diagnosis result. The administrator is capable of establishing a connection with the management server 30 by use of the administrator terminal 90, setting the variety of policies used for the management server 30 to manage the user terminals 10 and browsing the diagnosis results of the respective user terminals 10.

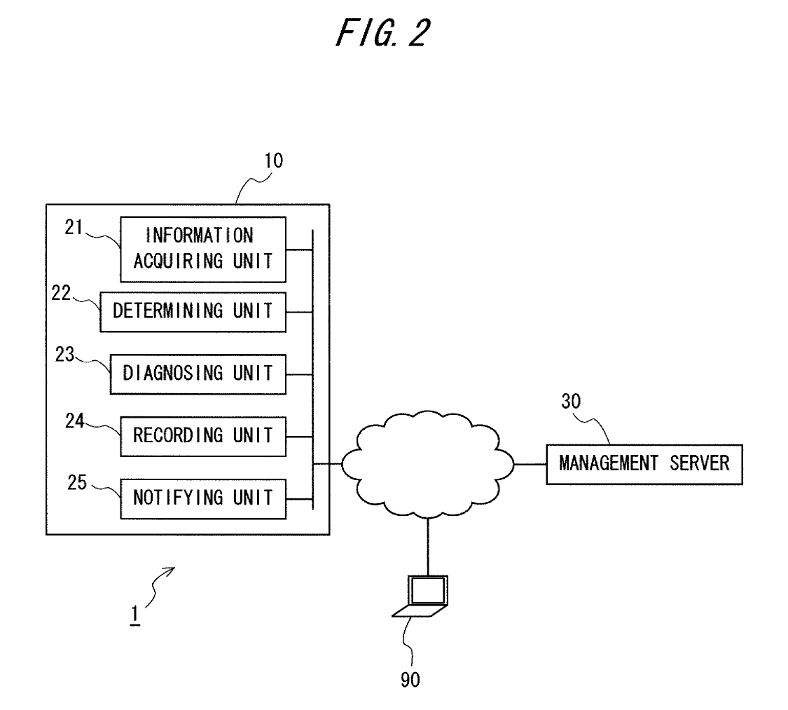

FIG. 2 is a diagram illustrating an outline of a functional configuration of the user terminal 10 according to the embodiment. Programs recorded in the storage device 14 are read to the RAM 13 and interpreted and executed by the CPU 11, whereby the user terminal 10 functions as the information processing device including an information acquiring unit (module) 21, a determining unit (module) 22, a diagnosing unit (module) 23, a recording unit (module) 24 and a notifying unit (module) 25. Note that the respective functions provided in the information processing device are executed by the CPU 11 classified as a general-purpose processor in the embodiment, however, a part or the whole of these functions may be executed by a single or a plurality of dedicated processors.

It is to be noted that the embodiment discusses the case in which the processes executed by the information processing device of this disclosure are all carried out by the user terminal 10. A part of the processes executed by the user terminal 10 may, however, be executed by another device connected to the user terminal 10. In this case, a combination of the user terminal 10 and the management server 30 or another device corresponds to the information processing device according to this disclosure.

<Flow of Process>

Next, a flow of process executed by the computer system 1 according to the embodiment will be explained by use of a flowchart.

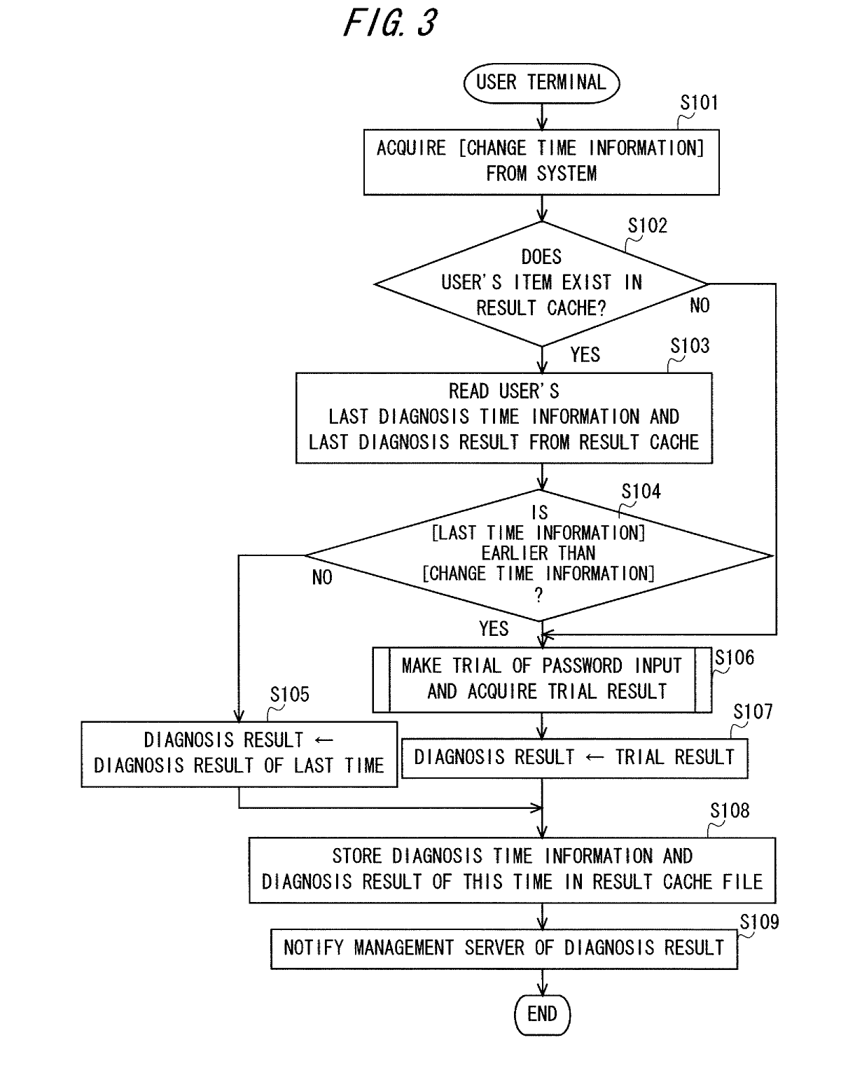

FIG. 3 is a flowchart illustrating a flow of the password diagnosis process according to the embodiment. The password diagnosis process according to the embodiment is periodically started on the user terminal 10. The start of the password diagnosis process may, however, be triggered by an event that the preset time is reached, an event that a fixed period of time elapses since the password diagnosis process of the last time, an event that the user conducts the log-in process, or an event that the administrator etc (the user is also available) issues an instruction of executing the password diagnosis process. Thus, the system logs each representing the failure in the password trial can be reduced also by restraining an execution count of the password diagnosis process itself. Note that a specific content and a specific processing sequence of the process illustrated in the flowchart are one examples for carrying out one aspect of this disclosure, and may also be properly selected corresponding to an embodiment.

In step S101, the OS acquires a piece of change time information. The information acquiring unit 21 of the user terminal 10 acquires, from the system, the change time information on a user (a password diagnosis target user) having an account in the system. The change time information is, e.g., information from which time of day and a date when the password is changed can be specified. To be specific, the information acquiring unit 21 can acquire the change time information by issuing API and a system call and analyzing the system log file. A specific method for acquiring the change time information is not limited to these examples.

Note that the change time information acquired in step S101 is used as reference time information for determining whether the password trial is required or not in step S104 that will be described later on. In the process illustrated in this flowchart involves using the change time information as the reference time information, however, password input time information (log-in success time information, console unlock time information, etc) may also be acquired as the reference time information in place with the change time information. Thereafter, the processing proceeds to step S102.

In step S102, it is determined whether the result cache of the password diagnosis target user exists or not. The information acquiring unit 21 refers to the result cache file and determines, based on existence or non-existence of the result cache (which is, specifically, the time information of the last time and the diagnosis result of the last time) of the password diagnosis target user (the user associated with the change time information acquired in step S101), whether the password diagnosis related to the user concerned was made in the past or not. If it is determined because of the existence of the result cache of the target user that the password diagnosis of the user concerned was made in the past, the processing proceeds to step S103. Whereas if it is determined because of the non-existence of the result cache of the target user that the password diagnosis of the user concerned was never made, the processing proceeds to step S106.

In step S103, the result cache is read out. The information acquiring unit 21 acquires the result cache (the time information of the last time and the diagnosis result of the last time) related to the password diagnosis target user or system from the result cache file. Thereafter, the processing proceeds to step S104.

In step S104, it is determined whether the time of last diagnosis is earlier than the change time or not. The determining unit 22 determines whether the time indicated by the change time information is earlier or later than the time indicated by the time information of the last time contained in the acquired result cache and further determines corresponding to a result of the determination whether the password trial is carried out or not. More specifically, the determining unit 22 compares the time indicated by the time information of the last time acquired in step S103 with the time indicated by the change time information acquired in step S101, and determines that the time of last diagnosis is earlier than the change time, in which case the processing proceeds to step S106. Whereas if it is determined that the time of last diagnosis is not earlier than the change time (i.e., the time of last diagnosis is later than or coincident with the change time), the processing proceeds to step S105.

Note that when acquiring in step S101 the password input time information (the log-in success time information, the console unlock time information, etc) as the reference time information in place of the change time information, the determining unit 22 determines whether the time indicated by the password input time information is earlier or later than the time indicated by the time information of the last time and further determines corresponding to a result of the determination whether the password trial is carried out or not. When determining that the time of last diagnosis is earlier than the password input time (the log-in success time, the console unlock time, etc), the processing proceeds to step S106. When determining that the time of last diagnosis is not earlier than the password input time, the processing proceeds to step S105.

In step S105, the diagnosis result of the last time is set as the diagnosis result of this time. The change time information is not later than the time information of the last time, which implies that the password is not changed since the password diagnosis of the last time has been completed, and the password, which has already undergone the password diagnosis, is employed. Therefore, the diagnosing unit 23 does not execute a password trial (refer to step S106) that will be explained later on but adopts, in an as-is status, the diagnosis result of the last time contained in the result cache acquired in step S103 as the diagnosis result. Thereafter, the processing proceeds to step S108.

In step S106 and step S107, the password trial is carried out, and a result of the password trial is set as the diagnosis result of this time. The diagnosing unit 23 makes a trial of the easy-to-guess password prepared beforehand with respect to the system, thus checking whether or not the password set in the system by the user is coincident with the easy-to-guess password. A method of making the trail of the password input is exemplified by a method of actually inputting the password via an interface of the system, a method of receiving and transferring the password to the system by utilizing the API used for logging on to the system, a method of obtaining the hash value corresponding to the password and comparing this hash value with the password hash value acquired from the system, and so on. The diagnosing unit determines the validity of the password through the password trial using any one of these methods, thus setting this determination result as the diagnosis result.

Namely, the diagnosing unit 23, if succeeding in the password trial using the easy-to-guess password, can determine that the password set in the system by the user at the present is the easy-to-guess password. In this case, the diagnosing unit 23 outputs the diagnosis result (e.g., [NG]) having a meaning that [an invalid password is set]. Whereas if getting into the failure in the password trial using the easy-to-guess password, the diagnosing unit 23 can determine that at least the easy-to-guess password used for the trial of this time is not employed. In this case, the diagnosing unit 23 outputs the diagnosis result (e.g., [OK]) having a meaning that [at least some invalid passwords are not set]. Thereafter, the processing proceeds to step S108.

Further, one-time password diagnosis enables the trails of the plurality of easy-to-guess passwords. In the one-time password diagnosis, however, an upper limit may be set in the password trail count, and an interval may be set between the password trials. With this contrivance, if the wrong (invalid) passwords are inputted consecutively a predetermined number of times or more and if the wrong passwords are consecutively inputted without the predetermined interval, system-based lockout can be avoided.

Given herein is a description of the method of preparing the easy-to-guess password used for the password trial. The easy-to-guess password is exemplified such as a password identical with or similar to a user identifier (a log-in ID and a user name) in the system, a password consisting of only the same type of characters, a password using words intact which exist in dictionaries and a generally-used password. In the embodiment, the user terminal 10 executing the agent software prepares the password used for the password trial by utilizing a method of acquiring a password as the easy-to-guess password from a pre-compiled password list, a method of acquiring a user identifier from the system, a method of acquiring a processed user identifier into which the acquired user identifier is processed such as attaching characters to the identifier, a method of acquiring the password specified based on the policy etc set in the management server 30, and so forth.

In step S108, the diagnosis time information of this time and the diagnosis result are stored in the result cache file. The recording unit 24 updates the result cache associated with the target user, which is contained in the result cache file, with the diagnosis time information of this time and the diagnosis result. Herein, the diagnosis time information of this time connotes the time information on the password diagnosis of this time and is exemplified such as the time information when conducting the password trial (step S106) and the time information when making the time-comparison (step S104). In the case of determining in step S104 that the password diagnosis is not carried out, however, though the time information on the password diagnosis within the result cache is updated with the time information on the password diagnosis of this time, as for the diagnosis result within the result cache, consequently the diagnosis result of the last time is kept intact. This is because the diagnosis result of the last time is adopted intact as the diagnosis result in step S105.

Further, if the password diagnosis of this time is the first password diagnosis related to the target user, the result cache of the target user does not exist in the result cache file. Therefore, when the first password diagnosis related to the target user is completed, the result cache of this user is newly added to the result cache file. Thereafter, the processing proceeds to step S109.

Note that the diagnosis result and the time information on the password diagnosis, which are stored in step S108, are read from the result cache file as the diagnosis result of the last time and the time information of the last time in the password diagnosis process of the next time (step S103).

In step S109, the management server 30 is notified of the diagnosis result. The notifying unit 25 transmits the result of the password diagnosis of this time, which contains the diagnosis time information of this time and the diagnosis result, to the management server 30. The management server 30, when receiving the password diagnosis result transmitted by the notifying unit 25, accumulates the password diagnosis result in the storage device 34 in the way of being associated with the user information related to the diagnosis result. Thereafter, the process illustrated in this flowchart is finished.

The computer system 1 according to the embodiment realizes the effective password diagnosis having the small password comparison count owing to the process described above. The diagnosis result given by the password diagnosis system can be useful for displaying an alarm message to the user and creating a summarization report targeted at the system administrator. Hence, the computer system 1 according to the embodiment improves the security of the whole computer system 1.

### MODIFIED EXAMPLE

Note that there has been described the example of using the password change time and the password input time (the log-in success time, the console unlock time, etc) as the reference time for determining whether the password trial is required or not in the process illustrated in the flowchart of FIG. 3, however, the reference time may involve using the present time acquired from the system.

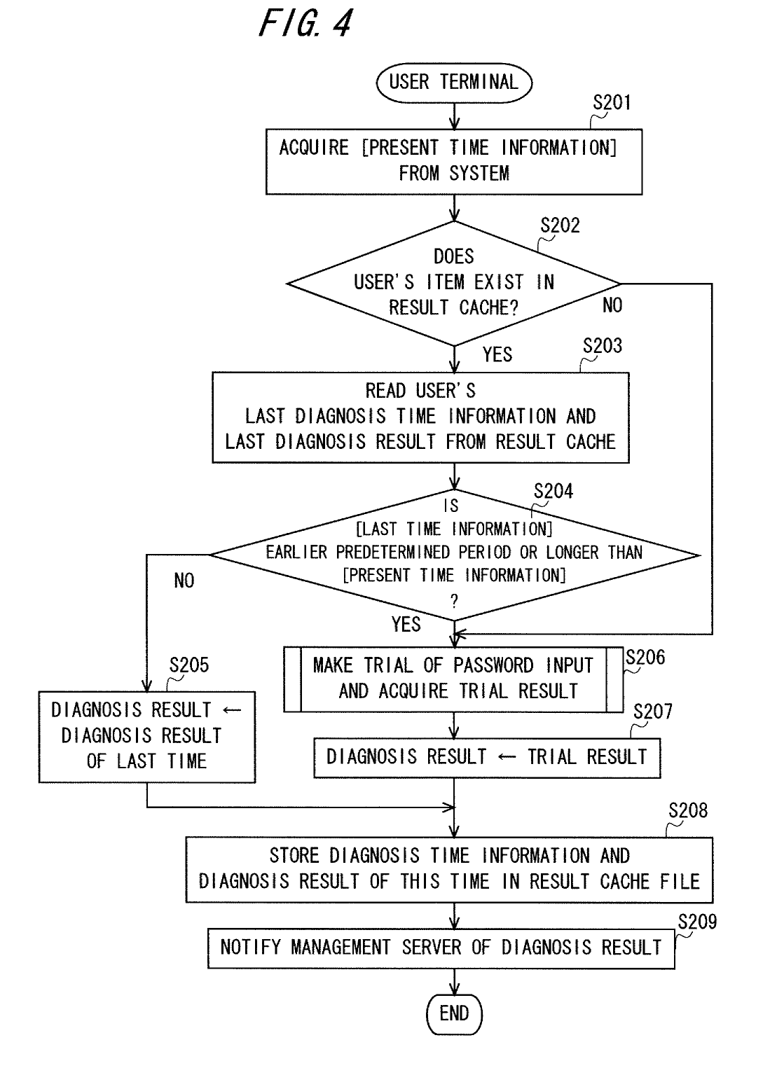

FIG. 4 is a flowchart illustrating a variation of the password diagnosis process according to the embodiment. The password diagnosis process illustrated in this flowchart may be executed as the substitute for the password diagnosis process shown in FIG. 3. The execution of the password diagnosis process is triggered as explained with reference to FIG. 3. Note that the specific content and the specific processing sequence of the process illustrated in the flowchart are examples for carrying out one aspect of this disclosure. The specific processing content and the specific processing sequence may be properly selected corresponding to an embodiment.

In step S201, the present time information is acquired from the OS. The information acquiring unit 21 of the user terminal 10 acquires the present time information from the system. The present time information may be, e.g., the time information acquired from an internal clock of the user terminal 10 at a point of time when starting the password diagnosis process illustrated in the flowchart and may also be pieces of time information acquired before and after starting the password diagnosis process. Thereafter, the processing proceeds to step S202.

The processes shown in step S202 and step S203 are substantially the same as the processes in step S102 and step S103 explained with reference to FIG. 3, and hence the descriptions thereof are omitted. Thereafter, the processing proceeds to step S204.

In step S204, it is determined whether the time of last diagnosis is earlier by a predetermined (e.g., one week) or longer period of time than the present time. The determining unit 22 determines whether or not the time indicated by the present time information elapses by the predetermined or longer period of time since the time indicated by the time information of the last time, and determines corresponding to the result of the determination whether the password trial is carried out or not.

Herein, the [predetermined period of time] may be set by the user in the agent software of the user terminal 10 and may also be set and retained as the policy in the management server 30 by the administrator via the administrator terminal 90. If the predetermined period of time is set in the management server 30, the user terminal 10 acquires, in advance of the process given in step S204, the predetermined period of time from the management server 30. As a result of the determination, if the time of last diagnosis is determined to be earlier by the predetermined or longer period of time than the present time, the processing proceeds to step S206. Whereas if the time of last diagnosis is determined not to be earlier by the predetermined or longer period of time than the present time (i.e., the predetermined period of time does not elapse for a period till the present time since the time of last diagnosis), the processing proceeds to step S205.

The processes from step S205 onward are substantially the same as the processes from step S105 onward explained with reference to FIG. 3, and hence their explanations are omitted. According to the process (password diagnosis process) shown in the flowchart, irrespective of whether the password is changed or not, if the predetermined period of time elapses since the diagnosis of the last time, the diagnosis result of the last time is invalidated, and the password diagnosis can be conducted afresh.

Moreover, the present time may be used in combination with the password change time and the password input time (the log-in success time, the console unlock time, etc) as the reference time for determining whether the password trial is required or not.

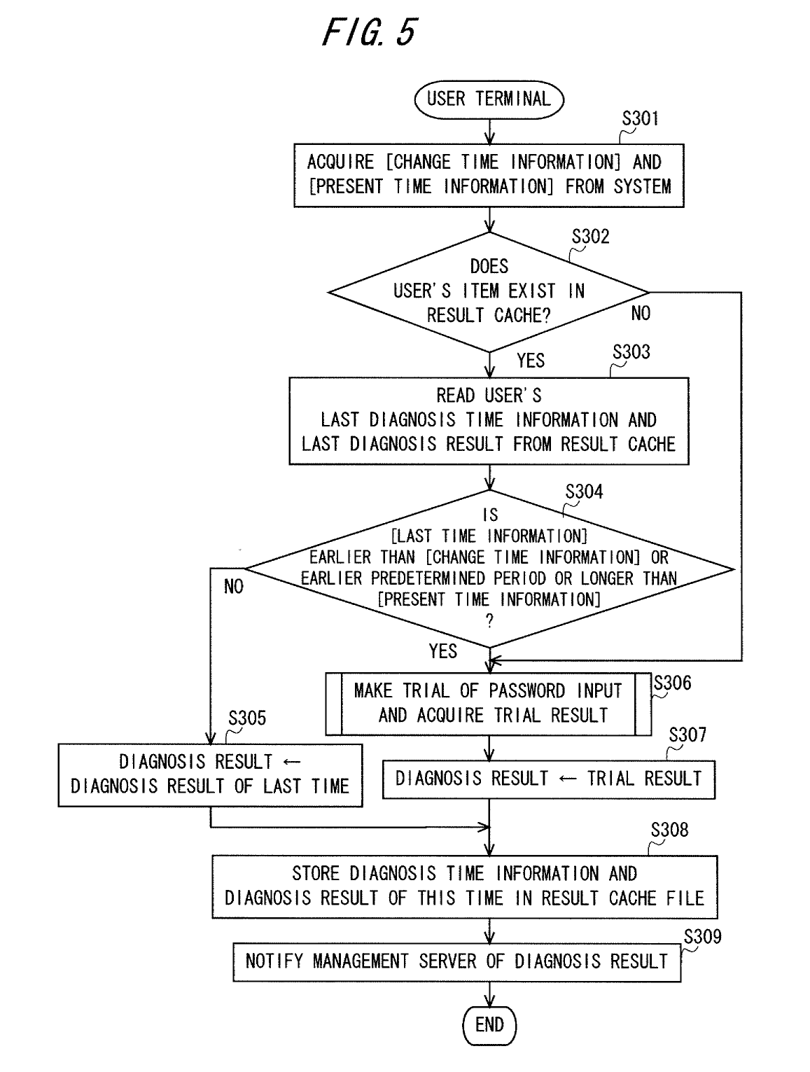

FIG. 5 is a flowchart illustrating a variation of the password diagnosis process according to the embodiment. The password diagnosis process shown in this flowchart may be executed as the substitute for the password diagnosis process shown in FIG. 3. The execution of the password diagnosis process is triggered as explained with reference to FIG. 3. Note that the specific content and the specific processing sequence of the process illustrated in the flowchart are examples for carrying out one aspect of this disclosure. The specific processing content and the specific processing sequence may be properly selected corresponding to an embodiment.

In step S301, the change time information and the present time information are acquired from the OS. The specific method by which the information acquiring unit 21 acquires change time information and the present time information is substantially the same as what has been described with reference to FIGS. 3 and 4, and hence its explanation is omitted. Thereafter, the processing proceeds to step S302.

The processes shown in step S302 and step S303 are substantially the same as the processes in step S102 and step S103 explained with reference to FIG. 3, and hence the descriptions thereof are omitted. Thereafter, the processing proceeds to step S304.

In step S304, it is determined whether the time of last diagnosis is earlier than the change time or earlier by a predetermined (e.g., one week) or longer period of time than the present time. The determining unit 22 determines whether or not the time of last diagnosis is earlier than the change time and further determines whether or not the time indicated by the present time information elapses by the predetermined or longer period of time since the time indicated by the time information of the last time. As a result of the determination, if coincident with any one of the conditions, the determining unit 22 determines that the password trial is performed.

Namely, according to the process (password diagnosis process) shown in the flowchart, the password trial is carried out if applied to any one of the case where the password is changed after the password diagnosis of the last time and the case where the predetermined period of time elapses since the password diagnosis of the last time. Under the thus-set determination condition, the password diagnosis can be conducted without any delay if the password is changed, and the password diagnosis can be performed afresh by invalidating the diagnosis result of the last time if the password is not changed for the predetermined or longer period of time. As a result, if determined to be coincident with any of the conditions, the processing proceeds to step S306. Whereas if determined not to be coincident with any conditions, the processing proceeds to step S305.

The processes from step S305 onward are substantially the same as the processes from step S105 onward explained with reference to FIG. 3, and hence their explanations are omitted. According to the process (password diagnosis process) shown in the flowchart, the password trial can be conducted if coincident with any one of the plurality of conditions, whereby the status of the computer system 1 can be kept more securely.

Further, in the password diagnosis process explained with reference to the flowchart of FIG. 5, if coincident with any one of the plurality of conditions, the password trial is carried out, however, in place of the determination of the condition such as this, the password trial may also be performed if coincident with the plurality of conditions. For instance, if the time of last diagnosis is earlier than the change time and earlier by the predetermined (e.g., one week) or longer period of time than the present time, the password trial is carried out, whereby it is feasible to reduce the frequency of the password diagnosis and further reduce a possibility of overlooking a malicious password analyzing action.

What is claimed is:

1. An information processing device comprising:
a diagnosing unit conducting a password diagnosis based on a password trial;
a recording unit recording time related to the password diagnosis;
an information acquiring unit acquiring the time related to the password diagnosis of the last time, which is recorded by said recording unit, as the time of last diagnosis and acquiring reference time for determining whether the password diagnosis is required or not; and
a determining unit determining whether or not the time of last diagnosis conforms with a predetermined condition with the reference time serving as a benchmark,
wherein said diagnosing unit, if said determining unit determines that the time of last diagnosis conforms with the predetermined condition with the reference time serving as the benchmark, performs the password diagnosis.

2. An information processing device according to claim 1, wherein the reference time is password change time, and
said diagnosing unit performs the password diagnosis if the time of last diagnosis is earlier than the password change time.

3. An information processing device according to claim 1, wherein the reference time is present time, and
said diagnosing unit performs the password diagnosis if the time of last diagnosis is earlier by a predetermined or longer period of time than the present time.

4. An information processing device according to claim 1, wherein the reference time is the password change time and the present time, and
said diagnosing unit performs the password diagnosis if the time of last diagnosis is earlier than the password change time or earlier by the predetermined or longer period of time than the present time.

5. A password diagnosing method by which a computer executes:
a diagnosing step of conducting a password diagnosis based on a password trial;
a recording step of recording time related to the password diagnosis;
an information acquiring step of acquiring the time related to the password diagnosis of the last time, which is recorded in said recording step, as the time of last diagnosis and acquiring reference time for determining whether the password diagnosis is required or not; and
a determining step of determining whether or not the time of last diagnosis conforms with a predetermined condition with the reference time serving as a benchmark,
wherein said diagnosing step includes, if it is determined in said determining step that the time of last diagnosis conforms with the predetermined condition with the reference time serving as the benchmark, performing the password diagnosis.

6. A non-transitory computer-readable medium recorded with a program for a password diagnosis, making a computer execute:
a diagnosing step of conducting a password diagnosis based on a password trial;
a recording step of recording time related to the password diagnosis;
an information acquiring step of acquiring the time related to the password diagnosis of the last time, which is recorded in said recording step, as the time of last diagnosis and acquiring reference time for determining whether the password diagnosis is required or not; and
a determining step of determining whether or not the time of last diagnosis conforms with a predetermined condition with the reference time serving as a benchmark,
wherein said diagnosing step includes, if it is determined in said determining step that the time of last diagnosis conforms with the predetermined condition with the reference time serving as the benchmark, performing the password diagnosis.
